(19) United States
(12) Patent Application Publication
(10) Pub. No.: US 2006/0140064 A1
(43) Pub. Date: Jun. 29, 2006

(54) Reset lever apparatus and electronic timepiece having the same

(76) Inventor: Taichi Haga, Chiba-shi (JP)

Correspondence Address: ADAMS & WILKS, 17 BATTERY PLACE, SUITE 1231, NEW YORK, NY, 10004, US

(21) Appl. No.: 11/318,912

(22) Filed: Dec. 27, 2005

(30) Foreign Application Priority Data
Dec. 28, 2004 (JP) 2004-380860

(51) Int. Cl. G04B 27/02; G04B 29/00

(52) U.S. Cl. 368/190; 368/319

(57) ABSTRACT

To provide a reset lever apparatus simplifying a shape and a structure thereof and easy to stabilize operation and an electronic timepiece having the same. A reset lever apparatus of an electronic timepiece includes a reset lever main body supported by a machine frame pivotably in J1, J2 directions between a reset position for making a hand movement by a rotation drive source unable when a winding stem is set to a hand driving drawn position and a nonreset position H1 for enabling the hand movement by the rotation drive source when the winding stem is set to a normal position, and released from being prohibited to displace from the nonreset position to the reset position when the winding stem is drawn from the normal position to the drawn position, and a reset lever deviating spring member which is formed separately from the reset lever main body and supported by the machine frame at a base portion on one end side thereof and other end side of which is extended in a direction orthogonal to the reset lever main body to exert a deviating force from the nonreset position to the reset position to the reset lever main body.

### BACKGROUND OF THE INVENTION

1. Field of the Invention

The present invention relates to a reset lever apparatus and an electronic timepiece having the reset lever apparatus.

2. Description of the Prior Art

There is known a reset lever supported pivotably by a machine frame between a reset position for making hand movement by a rotation drive source unable in setting a winding stem at a hand setting drawn position and a nonreset position for enabling hand movement by the rotation drive source in setting the winding stem at a normal position for releasing a displacement from the nonreset position to the reset position from being prohibited when the winding stem is drawn from the normal position to the drawn position (for example, JP-A-2004-93534, JP-UM-B-5-45995).

However, according to the reset lever of the background art, the pivoting reset lever per se is provided with a spring function and therefore, a spring portion needs to be constituted by a U-like shape actually, not only the reset lever is provided with a complicated shape along a space which the reset lever can occupy but also there is a concern that a spring force is difficult to be stabilized.

The invention has been carried out in view of the above-described point and it is an object thereof to provide a reset lever apparatus simplifying a shape and a structure thereof and easy to stabilize operation and an electronic timepiece having the same.

### SUMMARY OF THE INVENTION

In order to achieve the above-described object, a reset lever apparatus of the invention includes a reset lever main body supported by a machine frame pivotably between a reset position for making a hand movement by a rotation drive source unable when a winding stem is set to a hand driving drawn position and a nonreset position for enabling the hand movement by the rotation drive source when the winding stem is set to a normal position and released from being prohibited to displace from the nonreset position to the reset position when the winding stem is drawn from the normal position to the drawn position, and a reset lever deviating spring member which is formed separately from the reset lever main body and supported by the machine frame on one side thereof and in which other end side thereof engaged with the reset lever main body to exert a deviating force from the nonreset position to the reset position to the reset lever main body is extended in a direction intersecting with a pivoting face of the reset lever main body.

According to the reset lever apparatus, the reset lever main body and the reset lever deviating spring member are formed by separate members and therefore, the reset lever main body per se can substantially be formed as a rigid structure, not only the shape is simplified and operation is easy to stabilize but also integration thereof is facilitated and also fabrication cost can be minimized.

Further, the reset lever deviating spring member is formed separately from the reset lever main body and supported by the machine frame at the one end side, the other end side is extended in the direction intersecting with the pivoting face of the reset lever main body and engaged with the reset lever main body to exert the deviating force from the nonreset position to the reset position to the reset lever main body and therefore, the shape of the spring member can be simplified, the operation is easy to be stabilized and the integration can easily be carried out. Further, the intersecting direction is typically a vertical direction.

Here, typically, the machine frame refers to a support member of a main plate, a train wheel bridge or the like stationarilly placed to a timepiece case. However, the machine frame may be any other timepiece part so far as the part is stationarilly placed actually.

The reset lever main body typically includes a bearing portion or a shaft portion rotatably supported by the machine frame of, the timepiece main body, a winding stem contact portion exerted with a pressing force of the winding stem (typically, an end face or a side face of a front end portion of the winding stem), a reset terminal portion brought into contact with a reset pin or the like when pivoted to the reset position, and a spring receive portion engaged to a reset lever deviating spring portion, and the portions are formed as actually integral rigid structure. It is not necessary to provide the reset lever main body substantially with a spring function and therefore, a degree of freedom of the material and the size is considerably promoted, the reset lever main body can be formed by a drawn member in a flat plate shape of a sheet metal and therefore, the reset lever main body is easy to be fabricated and also fabrication cost can be minimized. Further, although the winding stem contact portion is provided with an elasticity to some degree since the winding stem contact portion is exerted with the pressing force of the winding stem, the spring elasticity for exerting a deviating force for pivoting to displace the reset lever main body is actually ensured by the reset lever deviating spring member and therefore, the winding stem contact portion can be formed with a rigidity far higher than that of the reset lever deviating spring member.

According to the reset lever apparatus, when the winding stem is disposed at a normal position, that is, at a winding stem 0 stage position for normal hand movement, the winding stem presses the reset lever main body against a deviating force of the reset lever deviating spring member to position the reset lever main body at the nonreset position. As a result, the reset lever main body (typically, a reset terminal position thereof) is maintained in a state of being separated from the reset pin. On the other hand, when the winding stem is drawn from the normal position (winding stem 0 stage position) to the drawn position (winding stem 1 stage position), the winding stem is released from being locked by the reset lever main body, the reset lever main body is pivoted by the deviating force of the reset lever deviating spring member to reach the reset position (typically, the reset terminal of the reset lever main body is brought into contact with the reset pin) to thereby make the hand movement by the rotation drive source unable. The processing of making the hand movement unable is typically carried out by stopping to supply a rotation drive signal to a motor constituting a rotation drive source.

Further, when the reset lever main body is set to the reset position, in order to prohibit an influence of hand driving by rotation of the winding stem from effecting on a second hand, a second wheel & pinion (minute wheel) and a fourth wheel & pinion (second wheel) are released from being engaged with each other. For that purpose, the reset lever main body is typically engaged with a shaft of a third wheel & pinion and when the reset lever main body is set to the reset position, in order to release the third wheel & pinion and the second wheel & pinion (minute wheel) or the fourth wheel & pinion from being brought in mesh with each other, a position of the shaft of the third wheel & pinion is shifted.

A reset lever apparatus of the invention typically includes a reset lever main body supported by a machine frame pivotably in a face in parallel with a main face of a timepiece main body between a reset position for making a hand movement by a rotation drive source unable when a winding stem is set to a hand driving drawn position and a nonreset position for enabling the hand movement by the rotation drive source when the winding stem is set to a normal position and released from being prohibited to displace from the nonreset position to the reset position when the winding stem is drawn from the normal position to the drawn position, and a plate-like structure having a base portion comprising a slender plate-like member a main face of which is arranged to be substantially orthogonal to the main face of the timepiece main body and which is held by the machine frame of the timepiece main body in a state of being extended in a direction of extending the main face of the timepiece main body, and a reset lever deviating spring portion projected from a side edge of the base portion in a thickness direction of the timepiece main body and constituted such that the spring portion exerts a deviating force from the nonreset position to the reset position to the reset lever main body.

In this case, the deviating force exerted to the reset lever main body is provided by the reset lever deviating spring portion of the plate-like structure. Further, in this case, the plate-like structure can be held by a machine frame of the timepiece main body at the slender base portion and therefore, the deviating force may be exerted to the reset lever main body by a spring portion of the plate-like structure (reset lever deviating spring portion). Further, according to the plate-like structure, the base portion comprising the slender plate-like member is arranged such that the main face becomes substantially orthogonal to the main face of the timepiece main body and extended in the direction of extending the main face of the timepiece main body and therefore, when viewed from the direction orthogonal to the main face of the timepiece main body, there is less concern of occupying a large place and therefore, the base portion is easy to be arranged at a desired position. Therefore, by additionally forming the spring portion to the plate-like structure having a desired function, also a number of parts can be minimized.

According to the reset lever apparatus, although the base portion of the plate-like structure may be supported directly or supported indirectly by the machine frame so far as the base portion is stationarily placed to the machine frame of the timepiece main body, typically, the base portion is constituted to be supported by the machine frame of the timepiece main body by being pinched by a groove portion or between projected portions of the machine frame of the timepiece main body. The projected portion may be arranged opposedly or arranged in zigzag. The projected portion may support the base portion in a state of line contact (point contact when viewed from the direction orthogonal to the main face of the timepiece main body) as in a pin or may support the base portion in a state of face contact (line contact when viewed from the direction orthogonal to the main face of the timepiece main body). In this case, according to the base portion, the main face becomes substantially orthogonal to the main face of the timepiece main body and can be extended in a direction of extending the main face of the timepiece main body and therefore, the base portion can be arranged and supported in a predetermined state even when the base portion is not fixed by screwing, calking or the like.

Further, in a state of being pinched by the groove portion or between the projected portions of the machine frame of the timepiece main body, the base portion of the plate-like structure may directly be held by side walls of the groove portion or the projected portions of the machine frame, in the state of being pinched by the groove portion or between the projected portions of the machine frame of the timepiece main body, the base portion may be held after elastically pressing an end portion thereof to a battery, a quartz can or the like in a loosely fitted state.

According to an electronic timepiece constituted by integrating the reset lever apparatus of the invention, the plate-like structure of the reset lever apparatus typically incorporates other function.

According to the electronic timepiece of the invention, typically, a winding stem positioning and engaging portion elastically engaged with a small diameter portion contiguous to an abacus bead shape portion having a large diameter of the winding stem and elastically deformed by the abacus bead shape portion when the winding stem is brought in and out to permit the abacus bead shape portion to pass therethrough is projected from a side edge of the base portion in a thickness direction of the timepiece main body. In this case, the plate-like structure of the reset lever apparatus can provide a click feeling in bringing in and out the winding stem without actually occupying an extra region. Further, by engaging the winding stem positioning and engaging portion with the winding stem, holding of the base portion of the plate-like structure formed with a reset lever deviating spring of the reset lever apparatus is easy to be ensured further stably.

Further, the electronic timepiece of the invention is typically constituted such that the above-described base portion of the reset lever apparatus is operated as a plate spring and constituted such that a battery is pressed by one end of the base portion and a quartz oscillator cabinet (quartz can) is pressed by other end thereof. In this case, the plate-like structure of the reset lever apparatus can simultaneously hold the battery and the quartz oscillator cabinet having comparatively large weights and devoid of a stabilized feeling without actually occupying an extra region. Further, by holding the battery and the quartz oscillator cabinet, holding of the base portion of the plate-structure formed with the reset lever deviating spring of the reset lever apparatus is easy to be ensured further stably.

Further, according to the electronic timepiece of the invention, typically, the above-described base portion of the reset lever apparatus comprises a plate spring made of a metal, therefore, the plate-like structure can be a pole terminal of the battery (typically, battery plus terminal).

### BRIEF DESCRIPTION OF THE SEVERAL VIEWS OF THE DRAWINGS

A preferred form of the present invention is illustrated in the accompanying drawings in which:

FIG. 1 is a plane explanatory view of a main body portion of an electronic timepiece of a preferable embodiment of the invention having a reset lever apparatus of a preferable embodiment of the invention (a state removing a train wheel bridge);

FIG. 2 is an explanatory view of a section taken along a line II-II of FIG. 1;

FIG. 3 is an explanatory view of a section taken along a line III-III of FIG. 1;

FIG. 4 is a perspective explanatory view of a plate spring structure of FIG. 1;

FIG. 5 is a plane explanatory view when the electronic timepiece of FIG. 1 is brought into a nonreset state; and

FIG. 6 is a plane explanatory view when the electronic timepiece of FIG. 1 is brought into a reset state.

### DETAILED DESCRIPTION OF THE PREFERRED EMBODIMENTS

Next, a preferable embodiment of the invention will be explained based on a preferable embodiment shown in attached drawings.

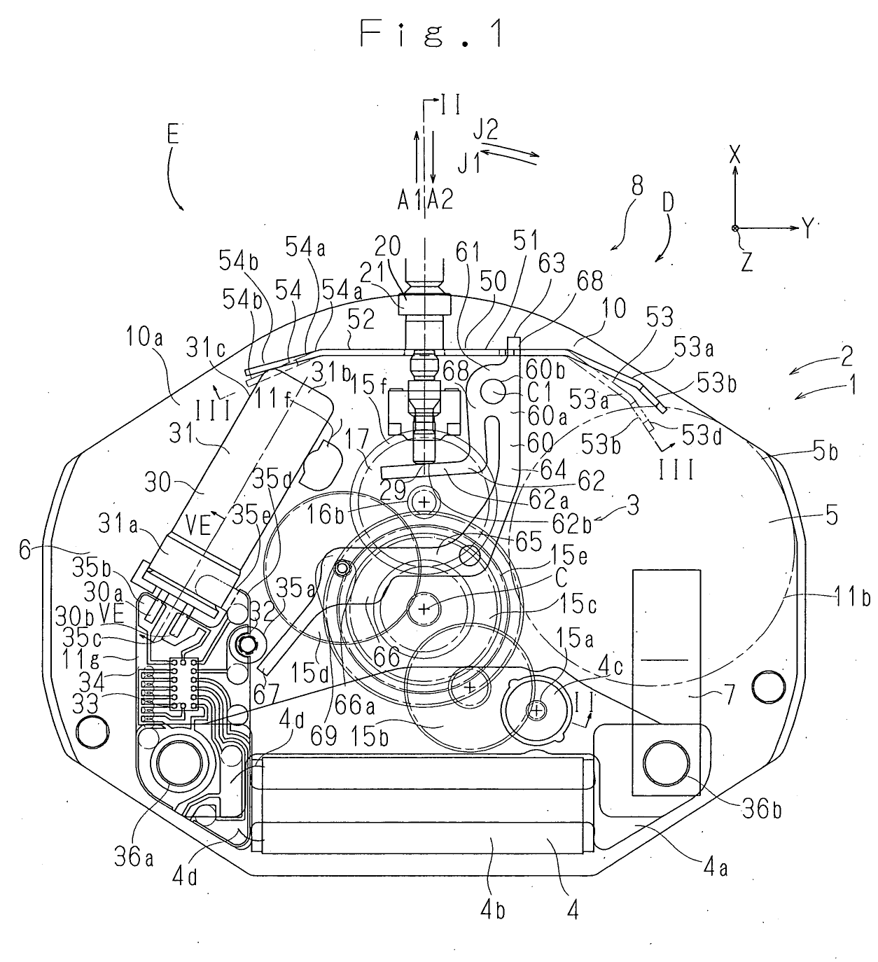

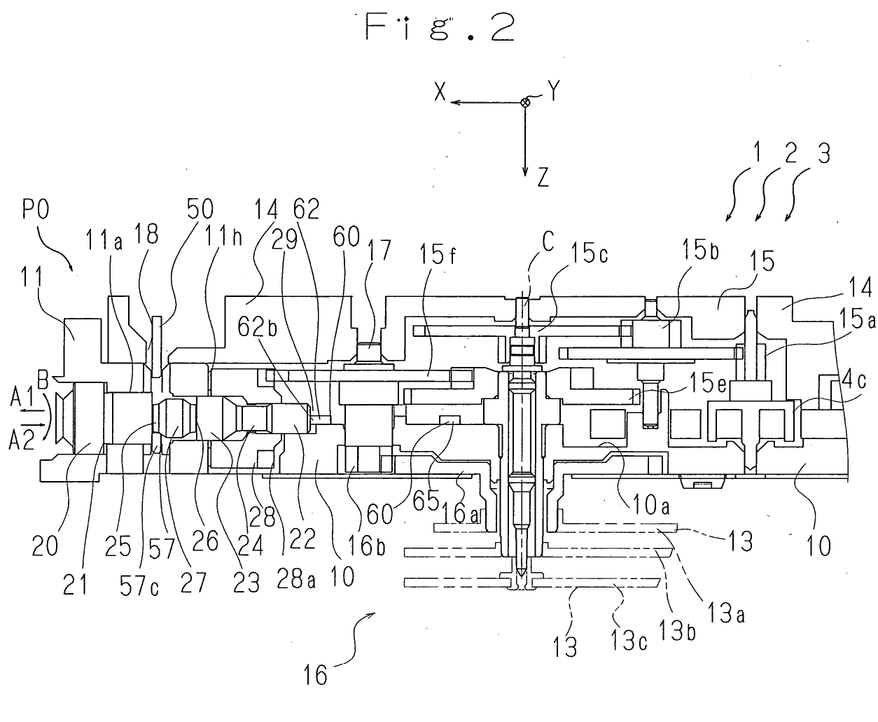

A timepiece main body 2 of an electronic timepiece 1 is provided with a main plate 10 constituting a machine frame. In the following, a three-dimensional coordinates system fixed to the main plate 10 is adopted for simplifying the explanation. Here, X direction is constituted by a direction A1 of drawing a winding stem 20 (3 o'clock side), Y direction is constituted by a right direction (12 o'clock side) in FIG. 1 and Z direction is constituted by a depth direction of the drawing orthogonal to the drawing. Z direction coincides with a side having a dial 12 (refer to FIG. 2). Here, XY plane is in parallel with a main face of the timepiece main body 2 and a direction of Z axis is a direction orthogonal to the main face of the timepiece main body 2. In FIG. 1 and FIG. 2, notation C designates a rotational center axis line of time display hands 13 (that is, hour hand 13a, minute hand 13b, second hand 13c) connected to a train wheel mechanism 3 of the timepiece main body 2. Here, the timepiece main body 2 indicates a portion excluding an exterior portion of a case or the like from the timepiece 1.

The main plate 10 is provided with recesses and projections and a surface shape suitable for arranging and supporting various timepiece elements to be positioned at respective positions of −Z side surface 10a of the main plate 10. The main plate 10 includes a side wall 11 (FIG. 2) having a winding stem guide hole 11a at a position on 3 o'clock side, and is provided with a quartz oscillator cabinet (quartz can) receiving projected portion 11f and a flexible circuit board mounting projected portion 11g projected at −Z side surface 10a as well as a clutch wheel receiving recess portion 11h formed at the surface 10a and a battery containing recess portion 11b specifying a portion of a peripheral wall by the side wall 11 or the like. Further, a reset pin 32 is implanted substantially in 5 o'clock direction of the hour hand in view from the center axis line C in the surface 10a of the main plate 10. The position of the reset pin 32 may be other position depending on arrangement and shape of a circuit board 34, mentioned later, or the like.

The winding stem 20 penetrating the winding stem guide hole 11a of the main plate 10 is provided with a square cylinder shape engaging shaft portion 22 at a front end, a cylindrical shape middle diameter shaft portion 23 at a middle, a cylindrical shape small diameter shaft portion 24 between the shaft portions 22, 23, an abacus bead shape portion 27 both sides in A1, A2 directions of which are specified by small diameter shaft portions 25, 26 in addition to a large diameter shaft portion 21 on a base end side, and is fitted to a clutch wheel 28. The clutch wheel 28 having a middle diameter hole portion on a base end side and a square cylinder shape hole portion on a front end side is disposed in the clutch wheel receiving recess portion 11h of the main plate 10 and is fitted to the winding stem 20 among the shaft portions 22, 24, 23. When the winding stem 20 is disposed at a 0-stage position (normal position) at which the winding stem 20 is pushed in A2 direction, the middle diameter hole portion and the square cylinder shape hole portion of the clutch wheel 28 are respectively fitted to the middle diameter shaft portion 23 and the small diameter shaft portion 24 of the clutch wheel 28 rotatably. On the other hand, when the winding stem 20 is disposed at a 1-stage position (drawn position) at which the winding stem 20 is drawn by one stage in A1 direction, the square cylinder shape hole portion of the clutch wheel 28 is engaged with the square cylinder shape engaging shaft portion 22 of the front end of the winding stem 20 and the clutch wheel 28 is rotated in accordance with rotation of the winding stem 20 in B direction. The clutch wheel 28 is brought in mesh with an eighth wheel 15f at a wheel portion 28a at a front end thereof.

As is known from FIG. 1, FIG. 2, the train wheel mechanism 3 includes a top side train wheel 15 disposed between the main plate 10 and a portion of a train wheel bridge 14 disposed at an interval from the main plate 10 in −Z direction and a bottom side train wheel 16 disposed on +Z side of the main plate 10. The train wheel bridge 14 can be regarded as a portion of a machine frame similar to the main plate 10. The top side train wheel 15 includes a sixth wheel & pinion 15a, a fifth wheel & pinion 15b, a fourth wheel & pinion (second wheel & pinion) 15c, a third wheel & pinion 15d, a second wheel & pinion (minute wheel & pinion) 15e, and the eighth wheel 15f, and the bottom side train wheel 16 includes an hour wheel 16a and an eighth pinion 16b. A shaft or a stem of the eighth wheel & pinion (minute wheel) 17 is extended to penetrate the main plate 10 in Z direction, the eighth wheel 15f is provided on a side of the top train wheel 15, and the eighth pinion 16b is provided on a side of the bottom side train wheel 16. A shaft portion of a shaft portion of the third wheel & pinion 15d proximate to the main plate 10 is fitted to a bearing hole 66a of a reset lever 60, mentioned later.

In FIG. 1, a motor 4 slender in Y direction is arranged at a position of the surface 10a of the main plate 10 on a side opposed to the winding stem 20, that is, on 9 o'clock side. In FIG. 1, on a right side of the winding stem 20 and the motor 4, a button type battery 5 is arranged at the battery containing recess portion 11b specifying a portion of the peripheral wall. Further, in FIG. 1, on a left side of the winding stem 20 and the motor 4, there is arranged a circuit block 6 including a flexible circuit board 34 mounted with an IC (integrated circuit) 33 for a timepiece and a quartz oscillator 30. The board 34 is mounted with also a circuit part other than IC 33 as desired.

The motor 4 includes a stator 4a and a coil block 4b as well as a rotor 4c and a shaft of the rotor 4c is formed with a rotor pinion constituting the sixth wheel & pinion 15a. The coil block 4b of the motor 4 is electrically connected to the flexible circuit board 34 by an extended portion 4d of the winding.

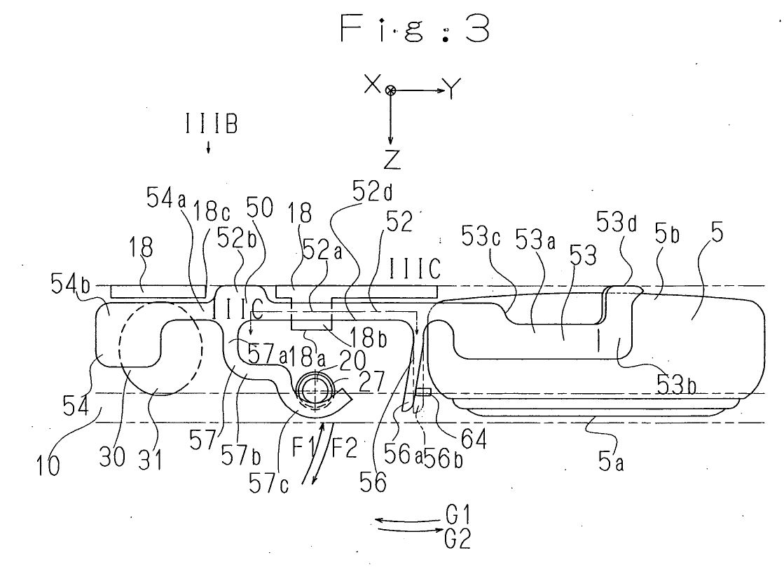

Notations 36a, 36b designate connecting portions for integrally connecting the stator 4a and the coil block 4b mechanically. At a location of the connecting portion 36a, the circuit board 34 is fixed to the motor 4 and at a location of the connecting portion 36b, a battery minus terminal 7 is fixed to the motor 4. The connecting portions 36a, 36b are provided with openings at centers thereof, projections projected from the main plate 10 are fitted and thermally calked to the openings, and a total of the motor 4, the circuit board 34 and the like is fixed to the main plate 10. The battery minus terminal 7 is extended to +Z side of the battery 5 along the surface 10a of the main plate 10 and is brought into contact with a negative pole 5a (FIG. 3) at an end face of the battery 5 mounted on the surface 10a of the main plate 10. The battery minus terminal 7 is electrically connected to the circuit board 34 via the motor 4 (for example, a winding core insulated from the stator member 4a and the winding of the coil block 4b or the like) to provide a minus potential of the battery 5 to the circuit board 34. That is, a conductive portion per se of the part of the motor 4 constitutes an electricity feeding line on a minus side of a power source in corporation with the battery minus terminal 7.

An end portion on −Z side of the shaft portion of the rotor 4c of the motor 4 is rotatably supported by the train wheel bridge 14. The coil block 4b having a large diameter of the motor 4 is projected in −Z direction and may be loosely fitted into a corresponding notch or opening (not illustrated) of the train wheel bridge 14 or may be held by the train wheel bridge 14. Similarly, also the battery 5 having a high height in −Z direction is loosely fitted into a corresponding battery attaching and detaching opening (not illustrated) of the train wheel bridge 14. When a premise is constituted by using the battery 5 in service life of the battery 5, the battery 5 may be pressed by the train wheel bridge 14.

At a center side side edge of the timepiece main body 2 in the surface on +Z side of the flexible circuit board 34 of the circuit block 6, a reset pin connecting conductive pad portion 35a is formed, and when the flexible circuit board 34 is mounted on the main plate projected portion 11g having a plane shape actually the same as that of the board 34 in the illustrated example, the conductive pad portion 35a is precisely brought into contact with −Z side end face (top face) of the reset pin 32. Naturally, the shape of the projected portion 11g may be different from that of the flexible circuit board 34 so far as the flexible circuit board 34 can be supported thereby by desired stability. Further, in a state of attaching the train wheel bridge 14, the train wheel bridge 14 presses the conductive pad portion 35a of the circuit board 34 to the top face of the reset pin 32. However, electric connection between the reset pin 32 and the circuit board 34 may be realized by a different mode.

The circuit block 6 is further formed with conductive patterns 35b, 35c, 35d and the conductive pattern 35d is attached with a connecting terminal piece portion 35e. The conductive pattern 35d is connected to an electricity feeding terminal of a power source voltage (potential) Vdd of IC 33 for the timepiece and the conductive patterns 35b, 35c are connected to terminals of the quartz oscillator 30. The conductive patterns 35b, 35c are electrically connected and fixed with a pair of connecting pins or connecting terminal portions 35a, 35b of the quartz oscillator 30 by soldering. The connecting terminal piece portion 35e electrically connected to the conducive-pattern 35d at a base end thereof is extended along the surface 10a of the main plate 10 and is brought into contact with +Z side portion of a peripheral face of a conductive can, that is, a base end portion 31a of a quartz can 31 as a cabinet of the quartz oscillator 30 mounted on the surface 10a of the main plate 10.

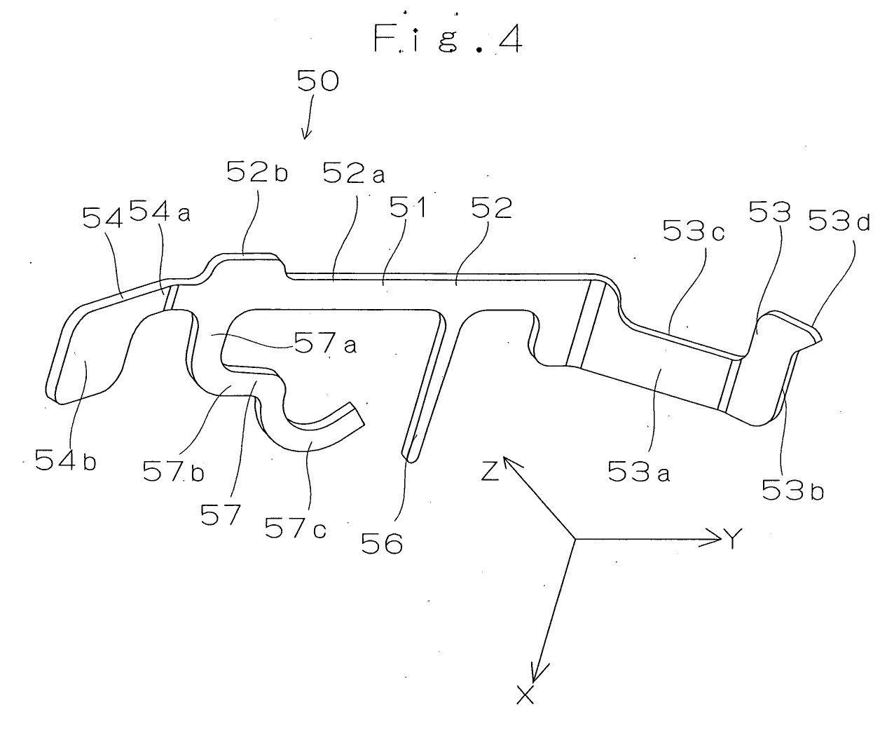

The train wheel bridge 14 is formed with a groove 18 (FIG. 2) as an engaging portion and a plate spring structure 50 made of a metal as a plate-like structure is locked by the groove 18. A main face or a surface of the plate spring structure 50 is orthogonal to an XY plane as shown by FIG. 3 and FIG. 4 in addition to FIG. 1 and FIG. 2. That is, a normal line relative to the main face of each portion of the plate spring structure 50 is disposed in a face in parallel with the XY plane regardless of the direction of the main face.

As is known from FIG. 1, FIG. 3 and FIG. 4, the plate spring structure 50 includes a main body portion 51 extended substantially in Y direction along the timepiece main body 2. The plate spring main body portion 51 is provided with a center portion 52 as a base portion extended in Y direction, a battery plus pole contact terminal portion 53 which is extended from an end portion in +Y direction of the center portion 52 to −X side in a skewed direction by an obtuse angle relative to the center portion 52 and a front end of which is brought into press contact elastically with a peripheral face of the battery 5 constituting a portion of a plus pole 5b of the battery 5, and a quartz can contact terminal portion 54 which is extended from −Y direction end portion of the center portion 52 to −X side in a skewed direction by an obtuse angle relative to the center portion 52 and a front end of which is brought into press contact elastically with a side edge 31c of a front end portion 31b of the quartz can 31 constituting the quartz oscillator cabinet. The plate spring structure 50 comprises a stainless steel alloy plate having a thickness of, for example, about 0.15 through 0.2 mm. Naturally, the thickness and the material may be different therefrom.

The battery plus pole contact terminal portion 53 includes an inclined arm portion 53a extended from an end portion in +Y direction of the center portion 52 to −X side in a skewed direction by an obtuse angle relative to the center portion 52, and a battery plus pole contact portion 53b further extended from a front end of the inclined arm portion 53a to −X side skewedly by an obtuse angle, and is brought into press contact with the battery plus pole 5b by a front end portion of the battery plus pole contact portion 53b. A fold-to-bend angle of the contact portion 53b relative to the center portion 52 is smaller than 90 degrees as a whole. According to the example, the center portion 52 is wide in a width thereof in Z direction at a vicinity of the end portion in +Y direction, and a side edge 53c on −Z side of the battery plus pole contact end portion 53 is partially notched. Further, the contact portion 53b of the front end of the battery plus pole contact end portion 53 ensures a wide contact region for the battery plus electrode 5b by providing a front end portion 53d rising in −Z direction and extended straight further frontward from the rising end portion (FIG. 3).

The quartz can contact end portion 54 is provided with a slender arm portion 54a and a quartz can contact portion 54b formed at a front end portion of the arm portion 54a in a wide width in Z direction, and is brought into press contact with the side edge 31c of the front end portion 31b of the quartz can 31 at the contact portion 54b.

Therefore, the plate spring structure 50 functions as a battery plus terminal directly applying the voltage (potential) of the plus pole 5b of the battery 5 to a power source terminal IC 33 via the contact terminal piece portion 35e and the conductive pattern 35d constituting the electricity feeding line by being brought into contact with the plus pole 5b of the battery 5 at the battery plus pole contact terminal portion 53 and brought into contact with the quartz can 31 at the quartz can contact terminal portion 54.

Further, the plate spring structure 50 having the above-described structure, and shape is formed by being folded to bend by an angle equal to or smaller than 90 degrees and in one direction as a whole relative to the center portion 52 and therefore, forming of a fold-to-bend die therefor and folded to bend operation can be carried out by minimum cost and time.

As shown by FIG. 3, the plate spring structure 50 is fitted to a groove 18b of a projected portion 18a of the engaging portion 18 of the train wheel bridge 14 at a center region 52a of the center portion 52 and is fitted to an opening portion 18c of the train wheel bridge 14 at the projected portion 52b formed at a side edge on −Z side of the center portion 52.

The center portion 52 of the plate spring structure 50 may be supported between, for example, a pair of projected portions (for example, pin-like objects) in place of the groove portion 18b. Further, the groove portion or the projected portion may be formed at the main plate 10 instead of being formed at the train wheel bridge 14, or may be formed at both of the train wheel bridge 14 and the main plate 10.

The plate spring structure 50 further includes a reset lever deviating spring portion 56 and a winding stem engaging spring portion 57 projected from a side edge portion thereof on +Z side. The winding stem engaging spring portion 57 includes a base side arm portion 57a extended in +Z direction from the main body portion 51, a front end side arm portion 57b extended from an extended end of the base side arm portion 57a in +Y direction, and a circular arc shape engaging portion 57c extended from a front end of the arm portion 57b and is elastically engaged with the small diameter portion 25 or 26 at a vicinity of the abacus bead shape portion 27 of the winding stem 20 at the circular arc engaging portion 57c.

The plate spring structure 50 comprises a plate spring extended in Y direction and having a width in Z direction as a whole and therefore, an area thereof occupied in X-Y plane can be minimized. Further, the plate spring structure 50 can be held by only being inserted into the groove portion 18b or the like and does not need a fixing structure of screwing, calking or the like and therefore, also a space necessary for holding the plate spring structure 50 can be minimized.

As is known from FIG. 1 and FIG. 3, the plate spring structure 50 is engaged with the engaging portion 18 of the train wheel bridge 14 and supported by the train wheel bridge 14 at the center portion 52, the battery plus pole-contact terminal portion 53 disposed at the end portion in +Y direction is brought into press contact elastically in D direction with the peripheral face of the plus pole 5b of the battery 5, the quartz can contact terminal portion 54 disposed at the end portion in −Y direction is brought into press contact elastically in E direction with the side edge 31c of the front end portion 31b of the quartz can 31 supported by the quartz oscillator cabinet bridge projected portion 11f of the main plate 10 (when desired, an end face on a base end side or a side edge of a base end portion of the quartz can 31 may be supported). Therefore, the plate spring structure 50 can elastically press the battery 5 and the quartz oscillator 30 by constituting a fulcrum by the engaging portion 18 of the train wheel bridge 14 and therefore, both of the battery 5 and the quartz-oscillator 30 sizes of which are larger than those of other parts to be easy to deteriorate mounting stability can simultaneously and stably be positioned to fix. Further, the plate spring structure 50 is brought into contact with the battery 5 by large contact pressure at one end thereof and brought into contact with the quartz can 31 of the quartz oscillator 30 by large contact pressure at other end thereof and therefore, the plus potential of the battery 5 can firmly be conducted to the quartz can 31. Further, the quartz can 31 is connected to the power source voltage feeding terminal of IC 33 of the circuit block 6 via the contact terminal piece portion 35e and the conductive pattern 35d and therefore, the cabinet of the quartz oscillator 30, that is, the quartz can 31 can directly be utilized for supplying the power source voltage. The quartz oscillator cabinet portion or the quartz can 31 occupies large volume or area in the main body portion 2 of the electronic timepiece 1 and therefore, a length of the battery plus terminal can be minimized.

Further, the spring structure 50 exerts an elastic force in F1 direction to the winding stem 20 by being engaged with the small diameter portions 25, 26 on both sides of the abacus bead shape portion 27 of the winding stem 20 at the circular arc shape engaging portion 57c of the winding stem engaging spring portion 57 and therefore, the winding stem 20 engaged elastically with the spring portion 57 by the small diameter portion 25 or 26 can elastically be held stably without being positionally shifted in A1, A2 direction and the winding stem 20 can be positioned. Further, since engagement between the spring portion 57 and the small diameter portion 25 or 26 is elastic engagement, for example, in the case in which the winding stem 20 is drawn in A1 direction when the winding stem 20 is disposed at 0-stage position and the circular arc shape engaging portion 57c of the spring portion 57 is engaged with the small diameter portion 25 of the winding stem 20, the abacus bead shape portion 27 is moved in A1 direction by elastically deforming the circular arc shape engaging portion 57c of the spring portion 57 to press down in F2 direction by the abacus bead shape portion 27 having a diameter larger than that of the small diameter portion 25. When the abacus bead shape portion 27 is passed through the spring portion 57 in A1 direction, the circular arc shape engaging portion 57c of the spring portion 57 is deformed again in F1 direction by an elastic recovery force and is fitted to the small diameter portion 26. Thereby, in drawing the winding stem 20 in A1 direction, the spring portion 57 of the spring structure 50 can provide a click feeling in corporation with the abacus bead shape portion 27. Also in pressing the winding stem 20 from winding stem 1 stage to winding stem 0 stage in A2 direction, the engaging portion 57c of the spring portion 57 is deformed to permit to pass the maximum diameter portion of the abacus bead shape portion 27 from the small diameter portion 26 and thereafter fitted to the small diameter portion 25 and therefore, a similar click feeling is provided.

Further, in supporting the spring portion 57 as described above, the spring structure 50 is not only held by the engaging portion 18 of the train wheel bridge 14 but also supported by the battery 5 and the quartz can 31 via the both end spring portions 53, 54 as reaction of elastically pressing the battery 5 and the quartz can 31 at the both end portions 53, 54 and therefore, support of the winding stem 20 can be stabilized in a stably held state. Further, in order to avoid the arm portions 57a, 57b of the winding stem engaging spring portion 57 from being considerably deformed in Y direction, restricting wall portions may be formed on +Y side and on −Y side of the arm portions 57a, 57b to interpose the arm portions 57a, 57b via gaps therebetween. The restricting wall portion may be a portion of the engaging portion 18 or the like.

Further, when desired, the surface 10a of the main plate 10 may be formed with a projected portion projected in −Z direction and the side edge portion 52d (FIG. 3) on +Z side of the center portion 52 of the spring structure 50 may be supported by the projected portion. In this case, the center portion 52 can firmly be prohibited from being displaced in +Z direction and therefore, the spring portion 57 can firmly provide the click feeling.

The electronic timepiece 1 is further provided with a reset lever 60 constituting the reset lever main body portion. According to the example, the reset lever 60 is provided with a plate-like portion 60a constituted by a drawn sheet metal member having a shape of a sea horse or the like as a whole, and a shaft portion 60b for rotatably supporting the plate-like portion 60a around a rotational center axis line C1 at a center portion relative to the main plate 10. The shaft portion 60b may rotatably be supported by a bearing hole of the main plate 10, or the plate-like portion 60a may be rotatable relative to the shaft portion 60b. The shaft portion 60b may further be supported by the main plate 10, or may be supported by the train wheel bridge 14 in place of the main plate 10. The plate-like portion 60a of the reset lever 60 comprises a stainless steel alloy plate having a thickness of, for example, 0.15 through 0.2 mm. Naturally, the thickness and the material may be different therefrom.

The reset lever plate-like portion 60a includes an L-like shape arm portion 62 extended from a center boss portion or a fat portion 61 extended to a region including the rotation center axis line C1 to a front end of the winding stem 20, a spring receive portion or an engaging projected portion 63 projected from the boss portion 61 in X direction and engaged with the spring portion 56, an up and down direction arm portion 64 extended from the boss portion 61 substantially in −X direction, a transverse direction arm portion 65 extended substantially in −Y direction from an extended end of the up and down direction arm portion 64 extended slightly skewedly while avoiding the battery 5, a fat portion for a bearing of the third wheel & pinion or a boss portion 66 formed at a front end of the arm portion 65, and a reset terminal portion 67 skewedly extended from the boss portion 66 to a location of the reset pin 32. In the above-described, the boss portion 61 as well as the L-like shape arm portion 62 and the engaging projected portion 63 constitute an input side lever portion 68 and the arm portions 64, 65, 67 and the boss portion 66 constitute an output side lever portion 69. Further, in the above-described, the reset lever apparatus 8 is constituted by the reset lever 60, and the spring portion 56 of the plate spring structure 50. Further, the reset lever apparatus 8 may be regarded to be constituted by the reset lever 60 and the plate spring structure 50 as a plate shape structure having the center portion 52 as a base portion and the spring portion 56.

When the winding stem 20 is disposed at winding stem 0 stage P0 pressed in A2 direction, a side edge 62b of a position detecting arm portion 62a on a front end side of the L-like shape arm portion 62 of the reset lever 60 is pressed in A2 direction from a front end face 29 of the winding stem 20. Although in order to avoid the winding stem 20 from being exerted with an excessive A1 direction reaction force, the L-like shape arm portion 62 can more or less be flexed typically, the L-like arm portion 62 is provided with a rigidity far higher than that of the reset lever deviating spring portion 56 of the plate spring structure 50 and can substantially be regarded as a rigid body so far as the L-like shape arm portion 62 is compared with the spring portion 56.

When the winding stem 20 is disposed at the winding stem 0 stage P0 pressed in A2 direction, the spring receive portion or the engaging projected portion 63 of the reset lever 60 is pressed in −Y direction relative to a side edge 56b on +Y side of a front end portion 56a of the reset lever deviating spring portion 56 of the plate spring structure 50 to elastically deform the deviating spring portion 56 to shift the front end portion 56a of the reset lever deviating spring portion 56 in G1 direction (bold line of FIG. 3).

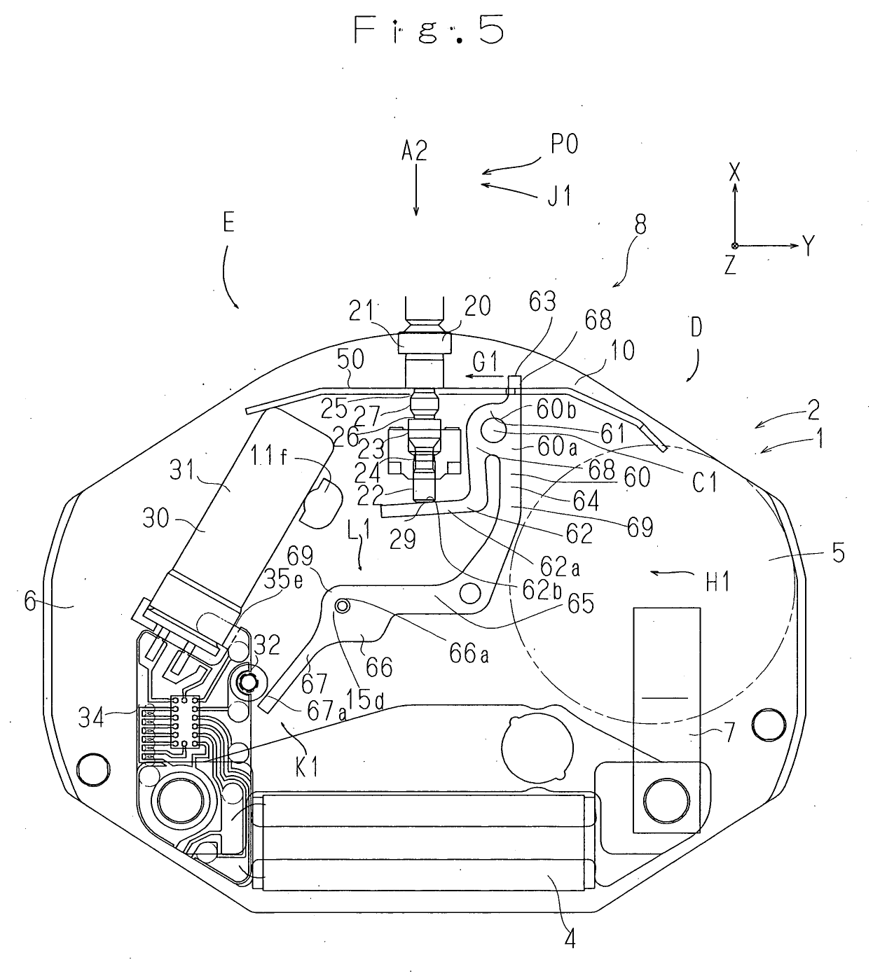

Therefore, when the winding stem 20 is disposed at the winding stem 0 stage, as shown by FIG. 5, the reset lever 60 adopts a nonreset position H1. That is, when the winding stem 20 is disposed at the winding stem 0 stage, the input side lever portion 68 presses the spring portion 56 of the plate spring structure 50 in G1 direction by being displaced to pivot in J1 direction under operation of the pressing force in A2 direction by the front end face 29 of the winding stem 20. Also the output side lever portion 69 of the reset lever 60 is displaced to pivot in J1 direction and the reset terminal portion 67 adopts a nonreset position K1 at which a side edge 67a of a front end thereof is separated from the reset pin 32. Further, when the reset lever 60 adopts the nonreset position H1, a third wheel & pinion support shaft bearing portion 66a adopts an engaging position L1, the third wheel & pinion 15d is brought in mesh with the second wheel & pinion 15e to transmit rotation of the fourth wheel & pinion 15c to the second wheel & pinion 15e.

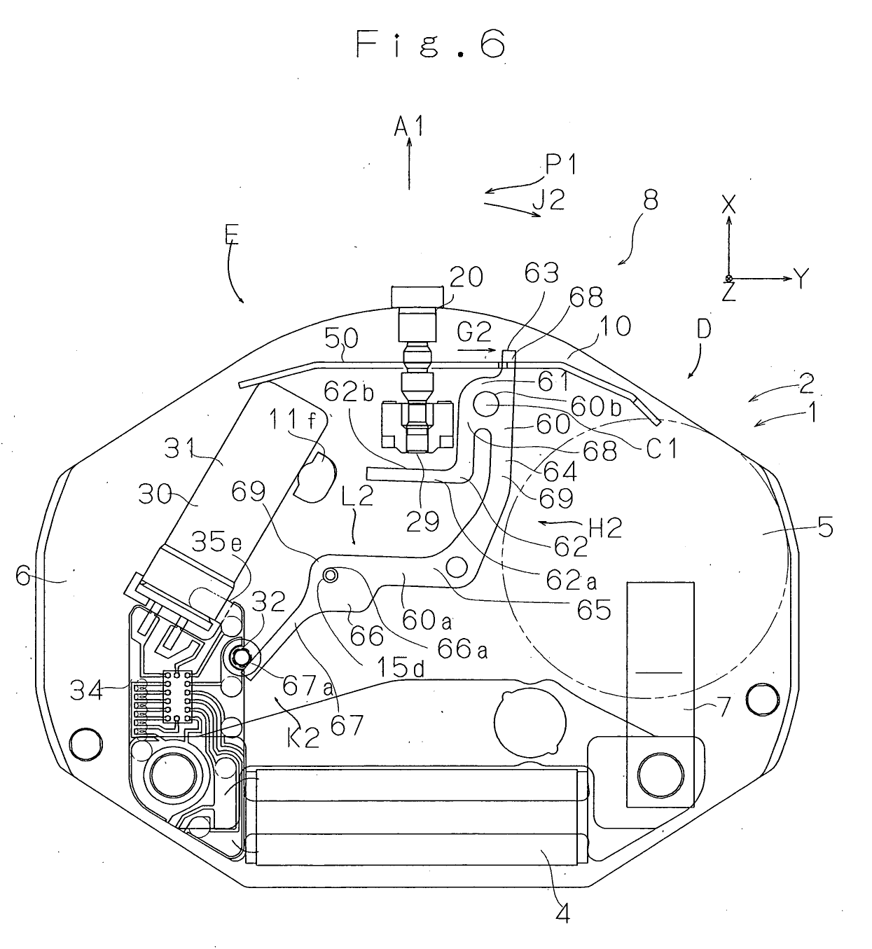

On the other hand, when as shown by FIG. 6, the winding stem 20 is drawn in A1 direction and adopts a winding stem 1 stage position P1, the front end face 29 of the winding stem 20 is moved in A1 direction, and is separated from the side edge 62b of the position detecting arm portion 62a of the L-like arm portion 62 of the reset lever 60. In accordance with releasing the input side lever portion 68 from the pivoting displacement force in J1 direction, the input side lever portion 68 is pivoted in J2 direction around the center axis line C1 by an elastic recovery force in G2 direction exerted to the projected portion 63 by the reset lever deviating spring portion 56 of the plate spring structure 50. Therefore, also the output side lever portion 69 is displaced to pivot in J2 direction, and the reset terminal portion 67 is pressed to the reset pin 32 at the side edge portion 67a of the front end. That is, when the winding stem 20 is drawn in A1 direction and adopts the winding stem 1 stage position P1, the reset lever 60 adopts a reset position H2, and the reset terminal portion 67 is set to a reset position K2 at which the reset terminal portion 67 is brought into contact with the reset pin 32. As a result, supply of a signal for driving the motor 4 from the circuit block 6 is stopped, rotation of the motor 4 is stopped, and the rotation of the second hand 13c is stopped. Further, when the reset lever 60 adopts the reset position K2, the third wheel & pinion support bearing portion 66a adopts a nonengaging position L2, the third wheel & pinion 15d and the second wheel & pinion 15e are released from being brought in mesh with each other, and rotation of the second wheel & pinion (minute wheel) 15e is not transmitted to the fourth wheel & pinion (second wheel) 15c. Details of a way per se of supporting the shaft of the third wheel & pinion by the reset lever 60 are disclosed in, for example, JP-A-2004-93534 or JP-UM-B-5-45995. Further, by displacing by the third wheel & pinion support bearing portion 66a, instead of releasing the third wheel & pinion 15d and the second wheel & pinion 15e from being brought in mesh with each other, the third wheel & pinion 15d and the fourth wheel & pinion 15c may be released from being brought in mesh with each other.

When the third wheel & pinion 15d and the second wheel & pinion 15e are released from being brought in mesh with each other, even when rotation of the winding stem 20 for hand movement is transmitted from the clutch wheel 28 to the hour wheel 16a and the second wheel & pinion (minute wheel) 15e via the minute wheel 17, rotation is not transmitted to the fourth wheel & pinion (second wheel & pinion) 15c and therefore, the minute hand 13b and the hour hand 13a can be set in a state of stopping the second hand 13c.

According to the reset lever apparatus 8 constituted as described above, the reset lever 60 and the spring structure 50 including the spring portion 56 are formed by separate members and therefore, the reset lever 60 per se can be formed substantially as a rigid structure, not only the shape is simplified but also fabrication cost can be minimized. Further, the reset lever deviating spring portion 56 is formed separately from the reset lever and is supported by the train wheel bridge 14 at the one end side, the other end side is extended in a direction orthogonal to a pivoting face XY of the reset lever and engaged with the spring receive portion 63 of the reset lever to exert a deviating force in G2 direction from the nonreset position H1 to the reset position H2 to the reset lever main body 60a and therefore, the shape of the spring portion 56 can be simplified, operation is easy to be stabilized and integration thereof can easily be carried out.

Further, according to the reset lever apparatus 8 of the embodiment, the reset lever 60 includes the bearing portion or the shaft portion 60b rotatably supported by the main plate 10 or the like constituting a machine frame of the timepiece main body, the winding stem contact portion 62a exerted with a pressing force of the front end portion 29 of the winding stem 20, the reset terminal portion 67 brought into contact with the reset pin 32 or the like when pivoted to the reset position H2, and the spring receive portion 63 engaged with the spring member 56, these portions are formed as an integral rigid structure, it is not actually necessary to provide the reset lever with the spring function essentially and therefore, a degree of freedom of the material and the size is considerably promoted, the integral rigid structure can actually be formed by a simple drawn member of sheet metal. Further, a shape of the reset lever main body 66a can pertinently be changed in accordance with positions of the front end portion of the winding stem 20, the reset pin 32, the third wheel & pinion bearing portion 66a and the reset lever deviating spring portion 56.

What is claimed is:

1. A reset lever apparatus including:
a reset lever main body supported by a machine frame pivotably between a reset position for making a hand movement by a rotation drive source unable when a winding stem is set to a hand driving drawn position and a nonreset position for enabling the hand movement by the rotation drive source when the winding stem is set to a normal position and released from being prohibited to displace from the nonreset position to the reset position when the winding stem is drawn from the normal position to the drawn position; and
a reset lever deviating spring member which is formed separately from the reset lever main body and supported by the machine frame on one side thereof and in which other end side thereof engaged with the reset lever main body to exert a deviating force from the nonreset position to the reset position to the reset lever main body is extended in a direction intersecting with a pivoting face of the reset lever main body.

2. A reset lever apparatus including:
a reset lever main body supported by a machine frame pivotably in a face in parallel with a main face of a timepiece main body between a reset position for making a hand movement by a rotation drive source unable when a winding stem is set to a hand driving drawn position and a nonreset position for enabling the hand movement by the rotation drive source when the winding stem is set to a normal position and released from being prohibited to displace from the nonreset position to the reset position when the winding stem is drawn from the normal position to the drawn position; and
a plate-like structure having a base portion comprising a slender plate-like member a main face of which is arranged to be substantially orthogonal to the main face of the timepiece main body and which is held by the machine frame of the timepiece main body in a state of being extended in a direction of extending the main face of the timepiece main body, and a reset lever deviating spring portion projected from a side edge of the base portion in a thickness direction of the timepiece main body and constituted such that the spring portion exerts a deviating force from the nonreset position to the reset position to the reset lever main body.

3. A reset lever apparatus according to claim 2, wherein the base portion is constituted to be supported by the machine frame of the timepiece main body by being pinched by a groove portion or between projected portions of the machine frame of the timepiece main body.

4. An electronic timepiece including the reset lever apparatus according to claim 2, wherein a winding stem positioning and engaging portion elastically engaged with a small diameter portion contiguous to an abacus bead shape portion having a large diameter of the winding stem and elastically deformed by the abacus bead shape portion when the winding stem is brought in and out to permit the abacus bead shape portion to pass therethrough is projected from a side edge of the base portion in a thickness direction of the timepiece main body.

5. An electronic timepiece including the reset lever apparatus according to claim 2, constituted such that the base portion is operated as a plate spring and constituted such that a battery is pressed by one end of the base portion and a quartz oscillator cabinet is pressed by other end thereof.
